(19) United States
(12) Patent Application Publication
(10) Pub. No.: US 2009/0277307 A1
(43) Pub. Date: Nov. 12, 2009

(54) Deep Water Bolt Removal Tool

(76) Inventor: Jefferson R. Scofield, Houston, TX (US)

Correspondence Address: FULBRIGHT & JAWORSKI, LLP, 1301 MCKINNEY, SUITE 5100, HOUSTON, TX, 77010-3095, US

(21) Appl. No.: 12/115,951

(22) Filed: May 6, 2008

(51) Int. Cl. B25B 23/00; B25B 13/00

(52) U.S. Cl. 81/57.4; 81/57.44

(57) ABSTRACT

The invention relates to a tool for loosening or tightening bolts on subsea structures. The tool grasps a portion of the structure and, using hydraulic wrenches, tightens or loosens bolts located on the structure.

### CROSS-REFERENCE TO RELATED APPLICATIONS

Not applicable.

### STATEMENT REGARDING FEDERALLY SPONSORED RESEARCH OR DEVELOPMENT

Not applicable

The invention relates to a tool for loosening or tightening bolts on deep water structures such as blow out preventers (BOPs”). The tool engages at least a portion of the deep water structure and then, using remotely controlled wrenches, loosens or tightens bolts located on the surface of the deep water structure.

### BACKGROUND OF THE INVENTION

Under water structures are often constructed with external access points that permit access to the interior of the structure.

One example of an access port are the hydraulic cylinder heads located on ram-type BOPs. In some instances, after the rams have engaged to close the well, pressure builds up within the BOP preventing the rams from opening. To relieve the pressure, it is necessary to remove or loosen the cylinder heads located on the BOP. This is very difficult to do in deep water operations.

Thus, there is a need for a tool which can remotely loosen and tighten bolts in deep water applications, particularly those which are used to attach cylinder heads to BOPs.

### BRIEF SUMMARY OF THE INVENTION

The invention is a tool for remotely loosening or tightening bolts on subsea structures, particularly BOPs. The invention comprises a means for attaching the tool to the subsea structure, and at least one wrench for loosening or tightening bolts on the exterior of the subsea structure. The tool is operated remotely using hydraulics or other means and can be placed and removed using remotely operated submersible vehicles.

The tool is designed such that it can remain attached to the structure while allowing the wrench to engage and disengage from a bolt and move so as to engage an adjacent bolt. This is accomplished by allowing the portion of the tool where the wrench is located to move relative to the attachment means. This movement can be facilitated by means of a remotely operated submersible vehicle.

### BRIEF DESCRIPTION OF THE DRAWINGS

FIG. 1 is a side view of the present invention;

FIG. 2 is a top view of the present invention;

FIG. 3 is a perspective view of the present invention;

FIG. 4 is a perspective view of alternate embodiments of the present invention.

### DETAILED DESCRIPTION OF THE INVENTION

The present invention is a tool for loosening or tightening bolts located on the exterior of subsea structures. In one embodiment, it is a tool for loosening the bolts that secure cylinder heads to subsea BOPs. The tool comprises a means for securing the tool to the subsea structure and at least one wrench for loosening or tightening bolts on a subsea structure.

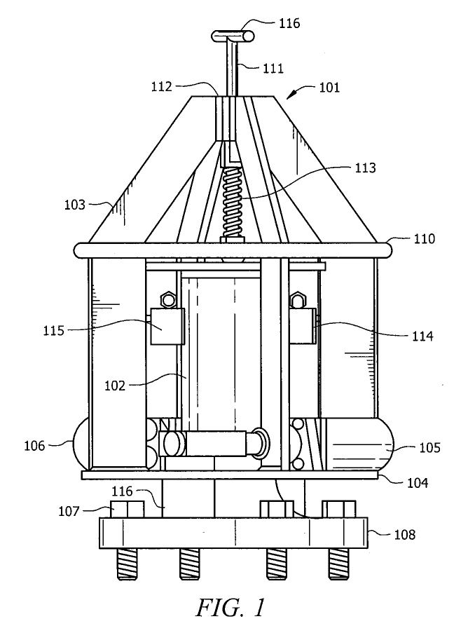

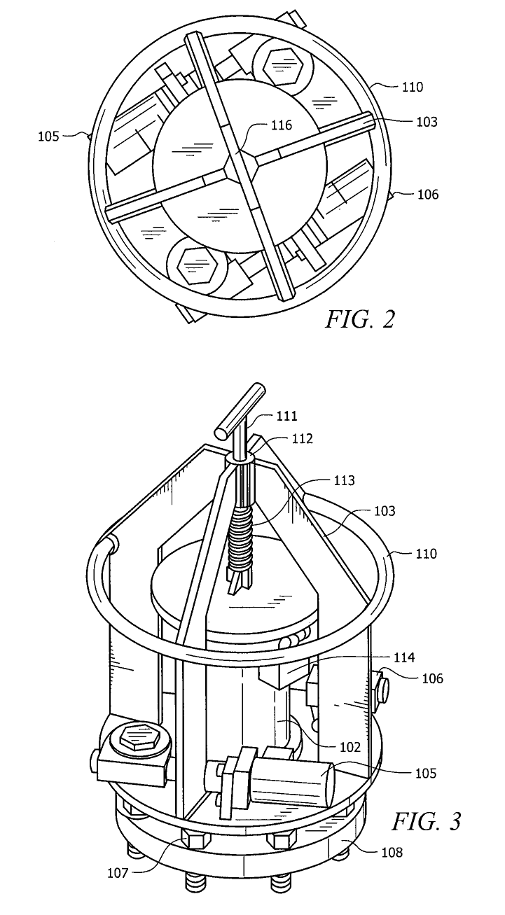

In the embodiment shown in FIG. 1, the tool 101 comprises a central cylinder 102 situated within a support frame 103. The cylinder and the frame are attached to a base plate 104 which has a central aperture (not shown) aligned with the cylinder 102. The tool also comprises torque wrenches 105, 106 attached to the base plate. The base plate comprises additional aperture which allow the wrench 105, 106 to engage the bolts 107, located on the pressure cap 108. The tool also comprises a ring 110 which enables the tool to be grasped by the arm of the submersible vehicle.

The cylinder is attached to the support frame by means of a rod 111 which passes through the apex 112 of the support frame. A spring 113 is used to bias the cylinder 102 against the frame 103 and allows the frame 103 to move parallel to the central axis of the cylinder 102. The rod 111 has a guide 117 at the distal end. The guide 117 aids in placing the tool over the cylindrical prospectus 116 of the pressure cap 108. This is typically accomplished using an unmanned submersible vehicle, which grasps the tool using the guide 117, the ring 110 or both.

Attached to the cylinder are hydraulic rams 114, 115 which when activated, extend through the walls of the cylinder 102 and engage a cylindrical projection on the pressure cap, locking the tool to the BOP pressure cap.

In operation, the tool is placed on the pressure cap such that the cylinder 102 slides over the cylindrical projection 116 of the pressure cap 108. The hydraulic rams are then activated, engaging the projective thereby holding the tool in place. Then the outer frame, base plate and wrenches, are drawn away from the pressure cap and rotated until the wrenches are aligned with the bolt heads. Typically, this is accomplished by using an unmanned submersible vehicle (USV). The USV engages the ring and then pulls the ring and frame away from the subsea structure and rotates the frame until the wrenches are situated above the set of bolts to be loosened or tightened. Once the frame and wrenches are in the desired position, the frame is then allowed to move back towards the pressure cap allowing the wrenches to engage the bolts. The number of bolts engaged will depend upon the number of wrenches used in the tool. In the embodiment shown in the Figs., two hydraulic torque wrenches are used; however, those skilled in the art will appreciate as few as one wrench may be used, with the upper limit being limited by the size of the tool and the size of the wrenches.

Once the wrenches have engaged the bolts, the wrenches are hydraulically activated to either loosen or tighten the bolts as desired. Once this is accomplished, the frame can be retracted and rotated again allowing engagement and loosening of successive sets of bolts until the pressure cap is removed or replaced.

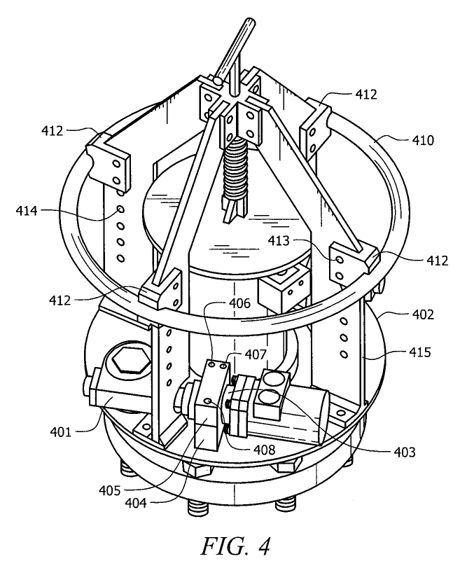

Referring to FIG. 4, two alternate embodiments are shown. In the first embodiment, the torque wrench 401 allow for changes in the position and/or alignment of the wrenches with respect to the remainder of the tool 402. In the embodiment shown in FIG. 4, the shaft 403 of the torque wrench 401 is engaged by lower 404 and upper 405 torque reaction plates. Screws 406 and 407 are tightened to hold the plates 404 and 405, against the torque wrench shaft 403 and a third screw 408 secures the plates 404 and 405 against the tool 402.

In operation, the three screws 406, 407 and 408 can be loosened, allowing the torque wrench 401 to move with respect to the tool 402. Three distinct movements can be performed when the screws are loosened: 1) the wrench can be rotated about the long axis of the wrench; 2) the wrench can be moved left or right along the long axis of the wrench; and 3) the wrench can be rotated about the axis of screw 408. In this last axis of rotation, the wrench will typically be limited to ±7 degrees about the axis of screw 408.

FIG. 4 also illustrates an embodiment where the orientation of the handling ring with respect to the tool can be adjusted. In FIG. 4, the handling ring 410 is attached to the frame 415 by means of brackets 412. The brackets have holes 413 designed to receive bolts for securing the handling ring to the frame. The holes 413 in the brackets can align with holes 414 in the frame 415. The position of the handling ring 410 with respect to the tool 402 can be altered by changing the location of the brackets 412 with respect to the frame 415.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A tool for removing bolts from a subsea structure comprising:
a) a means for attaching the tool to said subsea structure;
b) at least one wrench associated with said attaching means said wrench disposed to engage at least one bolt on said subsea structure.

2. The tool of claim 1 wherein said attaching means comprises a central cylinder having at least one hydraulic cam associated with said cylinder.

3. The tool of claim 1 further comprising a support frame connecting said wrench to said attaching means.

4. The tool of claim 1 wherein said support frame and said wrench are capable of parallel and rotational movement with respect to said attachment means.

5. The tool of claim 1 comprising two wrenches associated with said attachment means.

6. The tool of claim 3 wherein said wrenches are capable of movement with respect to the support frame.

7. The tool of claim 3 further comprising a handling ring attached to said support frame.

8. The tool of claim 7 wherein the position of said handling ring can be adjusted with respect to said support frame.

9. A tool for removal of bolts on subsea structures comprising:
a) a central cylinder;
b) a support frame connected to said cylinder;
c) a base plate associated with said frame and said cylinder;
d) at least one wrench attached to said base plate.

10. The tool of claim 6 wherein said frame, base plate and wrench are capable of movement parallel to said cylinder and rotationally about said cylinder.

11. The tool of claim 9 further comprising a handling ring attached to said support frame.

12. The tool of claim 11 wherein the position of said handling frame can be varied with respect to said support frame.

13. The tool of claim 9 wherein the position of said wrenches relative to said base plate can be varied.
